(19) United States
(12) Patent Application Publication
(10) Pub. No.: US 2018/0039858 A1
(43) Pub. Date: Feb. 8, 2018

(54) IMAGE RECOGNITION APPARATUS, IMAGE RECOGNITION SYSTEM, AND IMAGE RECOGNITION METHOD

(71) Applicant: Renesas Electronics Corporation, Tokyo (JP)

(72) Inventors: Akira UTAGAWA, Tokyo (JP); Takaaki SATO, Tokyo (JP); Atsushi NAKAMURA, Tokyo (JP); Manabu KOIKE, Tokyo (JP); Masaya ITOH, Tokyo (JP)

(21) Appl. No.: 15/600,741

(22) Filed: May 21, 2017

(30) Foreign Application Priority Data
Aug. 3, 2016 (JP) 2016-152688

(51) Int. Cl. G06K 9/62; G06F 17/30; G06K 9/46

(52) U.S. Cl. CPC G06K 9/6212; G06K 9/4642; G06K 9/4609; G06F 17/30256; G06K 9/4652; G06K 9/68

(57) ABSTRACT

An image recognition apparatus 100 includes a gradient feature computation unit 120 configured to calculate, from an image divided into a plurality of blocks, gradient feature values for each of the plurality of blocks, a combination pattern storage unit 160 configured to store a plurality of combination patterns of the gradient feature values, and a co-occurrence feature computation unit 131 configured to calculate a co-occurrence feature value in a plurality of blocks for each of the plurality of combination patterns. Further, image recognition apparatus 100 includes an arithmetic computation unit 132 configured to calculate an addition value by adding the co-occurrence feature value calculated for each of the plurality of blocks for each of the plurality of combination patterns, a statistical data generation unit 140 configured to generate statistical data from the addition value. Further, image recognition apparatus 100 includes an image recognition computation unit configured to define a window having a predetermined size for the image and recognize whether or not a predetermined image is included in the window based on the statistical data within the window.

### CROSS-REFERENCE TO RELATED APPLICATIONS

This application is based upon and claims the benefit of priority from Japanese patent application No. 2016-152688, filed on Aug. 3, 2016, the disclosure of which is incorporated herein in its entirety by reference.

### BACKGROUND

The present invention relates to an image recognition apparatus, for example, to an image recognition apparatus that exhibits high detection performance in a short processing time.

In recent years, sophisticated pattern recognition techniques have been required for achieving autonomous traveling and autonomous driving for mobile and in-vehicle purposes. However, computing powers of image recognition apparatuses installed in mobile devices and in-vehicle devices are limited. Therefore, it has been required to develop an algorithm capable of exhibiting high recognition performance with a small amount of calculation.

According to Japanese Unexamined Patent Application Publication No. 2015-15014, feature values of an image acquired in the form of binary data are input to a feature value transformation apparatus and combinations of co-occurrence feature values are calculated by its logical computation unit. Then, non-linear transformation feature vectors are generated by unifying these calculation results.

### SUMMARY

However, the present inventors have found the following problem. The apparatus disclosed in Japanese Unexamined Patent Application Publication No. 2015-15014 calculates all the combinations for the elements of the acquired feature vectors, thus causing a problem that the processing time is long.

Other objects and novel features will be more apparent from the following description in the specification and the accompanying drawings.

According to one embodiment, an image recognition apparatus includes: a gradient feature computation unit configured to calculate, from an image divided into a plurality of blocks, gradient feature values for each of the plurality of blocks; a combination pattern storage unit configured to store a plurality of combination patterns of the gradient feature values; a co-occurrence feature computation unit configured to calculate a co-occurrence feature value in a plurality of blocks for each of the plurality of combination patterns; an arithmetic computation unit configured to calculate an addition value by adding the co-occurrence feature value calculated for each of the plurality of blocks for each of the plurality of combination patterns; a statistical data generation unit configured to generate statistical data from the addition value; and an image recognition computation unit configured to define a window having a predetermined size for the image and recognize whether or not a predetermined image is included in the window based on the statistical data within the window.

Note that those that express the above-described apparatus according to the embodiment as a method or a system, programs that cause a computer to implement the aforementioned apparatus or a part of the above-described apparatus, image-pickup apparatuses including the aforementioned apparatus are also regarded as embodiments according to the present invention.

According to the above-described embodiment, it is possible to provide an image recognition apparatus that exhibits high detection performance in a short processing time.

### BRIEF DESCRIPTION OF THE DRAWINGS

The above and other aspects, advantages and features will be more apparent from the following description of certain embodiments taken in conjunction with the accompanying drawings, in which:

FIG. 1 is a functional block diagram according to a first embodiment;

FIG. 2 is a functional block diagram according to the first embodiment;

FIG. 3 is a hardware configuration diagram according to the first embodiment;

FIG. 4 is a diagram for explaining a gradient feature value according to the first embodiment;

FIG. 5 is a diagram for explaining a combination dictionary according to the first embodiment;

FIG. 6 is a diagram for explaining a process performed by a window calculation unit 180 according to the first embodiment;

FIG. 7 is a flowchart according to the first embodiment;

FIG. 8 is a flowchart according to the first embodiment;

FIG. 9 is a diagram for explaining a combination dictionary according to a second embodiment;

FIG. 10 is a diagram for explaining a process performed by a window calculation unit 181 according to the second embodiment;

FIG. 11 is a functional block diagram according to a third embodiment;

FIG. 12 is a functional block diagram according to the third embodiment;

FIG. 13 is a hardware configuration diagram according to the third embodiment;

FIG. 14A is a diagram for explaining a method for generating a dictionary according to the third embodiment;

FIG. 14B is a diagram for explaining a rearrangement of feature vectors according to the third embodiment;

FIG. 14C is a diagram for explaining a data update system for a dictionary according to the third embodiment;

FIG. 15 is a diagram for explaining an image transformation process according to the third embodiment;

FIG. 16 is a diagram for explaining a division of an image according to the third embodiment;

FIG. 17 is a flowchart according to the third embodiment;

FIG. 18 is a flowchart according to the third embodiment;

FIG. 19 is a diagram for explaining an arithmetic computation unit according to the third embodiment;

FIG. 20 is a functional block diagram according to a fourth embodiment; and

FIG. 21 is a hardware configuration diagram according to the fourth embodiment.

### DETAILED DESCRIPTION

For clarifying the explanation, the following descriptions and the drawings may be partially omitted and simplified as appropriate. Further, each of the elements that are shown in the drawings as functional blocks for performing various processes can be implemented by hardware such as a CPU, a memory, and other types of circuits, or implemented by software such as a program loaded in a memory. Therefore, those skilled in the art will understand that these functional blocks can be implemented solely by hardware, solely by software, or a combination thereof. That is, they are limited to neither hardware nor software. Note that the same symbols are assigned to the same components throughout the drawings and duplicated explanations are omitted as required.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### EMBODIMENTS

Firstly, an outline of a technique used in the below-explained embodiments is explained. Various techniques have been developed for performing pattern recognition by calculating feature values of an image. For examples, a technique called “HOG (histograms of oriented gradients)” has been widely known. In this technique, edge gradients in an image are acquired and a histogram of vectors is calculated. This is called “HOG feature values”. An image recognition apparatus can recognize an object in an image by analyzing the HOG feature values. Further, as another technique, an image recognition technique using “co-occurrence feature values” in which new feature values are generated by combining already-acquired feature values has been known. The use of the co-occurrence feature values makes it possible to roughly recognize a shape of an object by combining feature values of two different points.

### First Embodiment

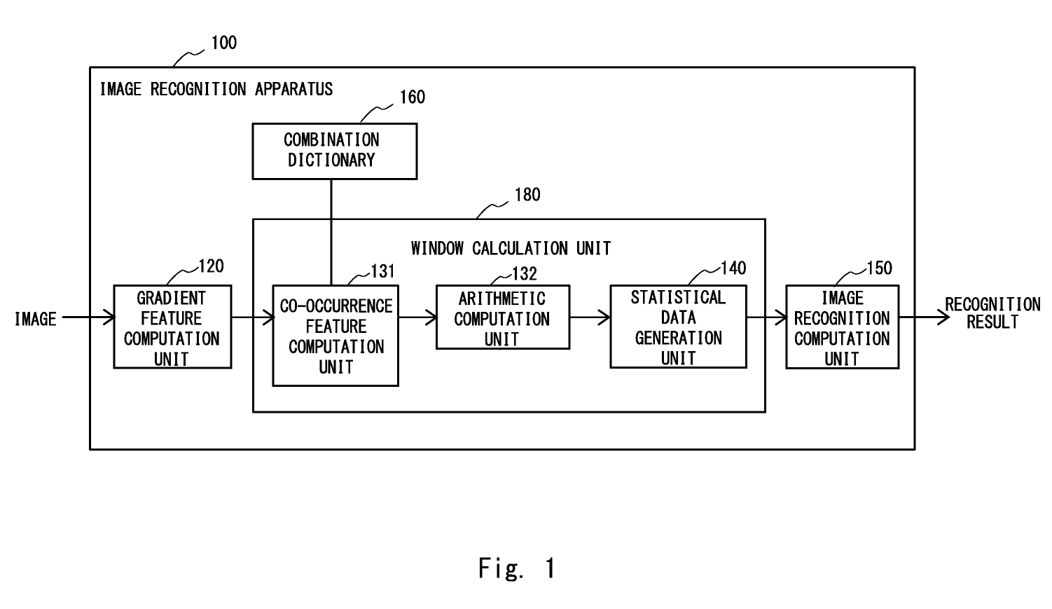

FIG. 1 is a diagram for explaining an outline of functional blocks of an image recognition apparatus according to a first embodiment. An image recognition apparatus 100 includes a gradient feature computation unit 120, a combination dictionary 160, a window calculation unit 180, and an image recognition computation unit 150. The window calculation unit 180 includes a co-occurrence feature computation unit 131, an arithmetic computation unit 132, and a statistical data generation unit 140.

When the image recognition apparatus 100 captures an image, it supplies the information to the gradient feature computation unit 120. The gradient feature computation unit 120 calculates gradient feature values of the image data (which is described later) and outputs the calculation result to the window calculation unit 180.

The window calculation unit 180 calculates feature values of an image within a window having a predetermined size and outputs the calculation result to the image recognition computation unit 150. Each of the function blocks included in the window calculation unit 180 is explained hereinafter.

The co-occurrence feature computation unit 131 receives a calculation result from the gradient feature computation unit 120, calculates co-occurrence feature values based on combination patterns stored in the combination dictionary 160, and outputs the calculation result to the arithmetic computation unit 132.

The arithmetic computation unit 132 receives the calculation result from the co-occurrence feature computation unit 131 and adds the co-occurrence feature values. The arithmetic computation unit 132 outputs the addition result to the statistical data generation unit 140.

The statistical data generation unit 140 receives the calculation result from the arithmetic computation unit 132 and generates statistical data. The statistical data is, for example, a histogram. The statistical data generation unit 140 outputs the generated data to the image recognition computation unit 150.

The image recognition computation unit 150 receives data from the arithmetic computation unit 132 and calculates (i.e., determines) whether or not an image to be recognized is included within the window. Note that the calculation performed by the image recognition computation unit 150 is, for example, calculation of a difference based on a predetermined threshold, a comparison based on a reference table, or the like. The image recognition computation unit 150 outputs the calculation result to the outside of the image recognition apparatus 100.

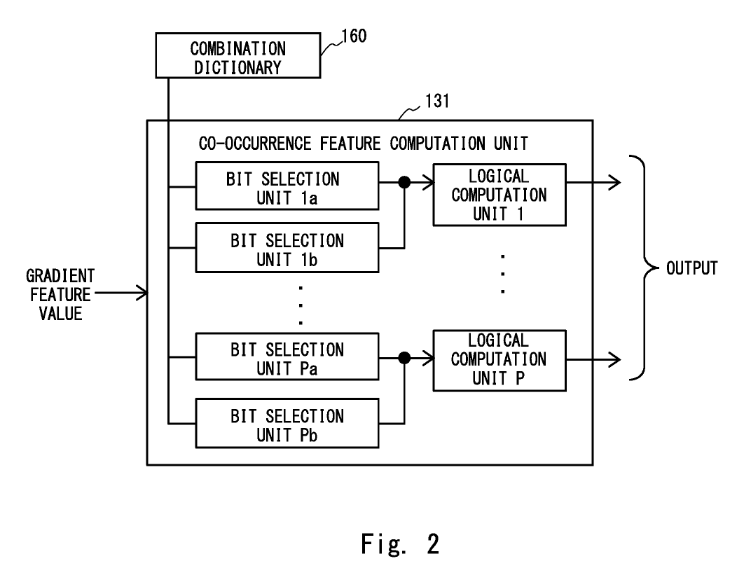

Next, details of the co-occurrence feature computation unit 131 are explained with reference to FIG. 2. The co-occurrence feature computation unit 131 includes a plurality of bit selection units (bit selection units 1a, 1b, . . . , Pa, and Pb) and a plurality of logical computation units (logical computation units 1, . . . , P). Each of the plurality of bit selection units refers to a combination pattern in the combination dictionary 160 and reads a gradient feature value. In the plurality of bit selection units, every two bit selection units form a pair. Further, each of the plurality of bit selection units outputs a value to a respective one of the plurality of logical computation units connected to that bit selection unit. Each of the plurality of logical computation units performs logical calculation using the value received from the respective one of the plurality of bit selection units, and outputs the calculation result. For example, the bit selection units 1a and 1b form a pair. Further, each of the bit selection units 1a and 1b outputs a value to the logical computation unit 1.

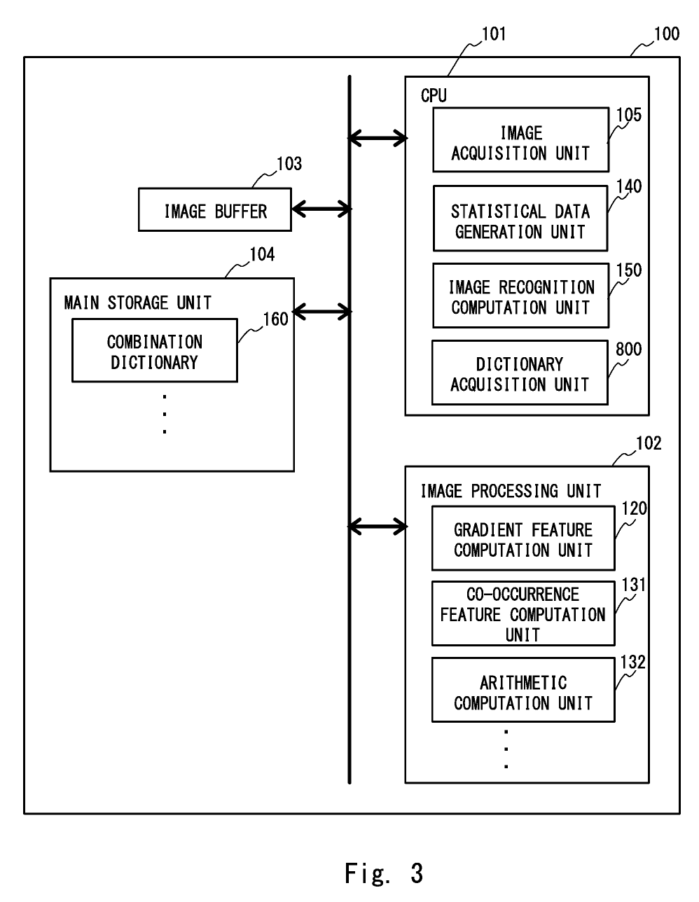

Next, FIG. 3 shows an example of a hardware configuration of the image recognition apparatus 100 according to the first embodiment. The image recognition apparatus 100 includes a CPU (Central Processing Unit) 101, an image processing unit 102, an image buffer 103, and a main storage unit 104. These components are connected to each other through a communication bus. Each of the CPU 101 and the image processing unit 102 is a processor that performs control and calculation. The image buffer is a primary storage device that temporarily accumulates captured images. For example, the image buffer is a DRAM (Dynamic Random Access Memory) or an SRAM (Static Random Access Memory). The main storage unit 104 stores the combination dictionary 160, and data and the like necessary for processing performed by the image recognition computation unit. The main storage unit 104 is a nonvolatile storage device. For example, the main storage unit 104 is an EEPROM (Electrically Erasable Programmable Read-Only Memory), a flash memory, or a FeRAM (Ferroelectric Random Access Memory).

The CPU 101 includes an image acquisition unit 105, a statistical data generation unit 133, an image recognition computation unit 150, and a dictionary acquisition unit 800. The image acquisition unit 105 performs a process for capturing an image and storing it into the image recognition apparatus 100. The dictionary acquisition unit 800 transfers information of the combination dictionary stored in the main storage unit to the image processing unit 102. The statistical data generation unit 140, the image recognition computation unit 150, the gradient feature computation unit 120, the co-occurrence feature computation unit 131, the arithmetic computation unit 132, and the combination dictionary 160 have the functions explained above with reference to FIG. 1, and therefore their explanations are omitted here.

Each block included in the CPU 101 and the image processing unit 102 is disposed therein as appropriate in view of its function. However, the arrangement of these components can be changed and the number of processors may be one or more than one.

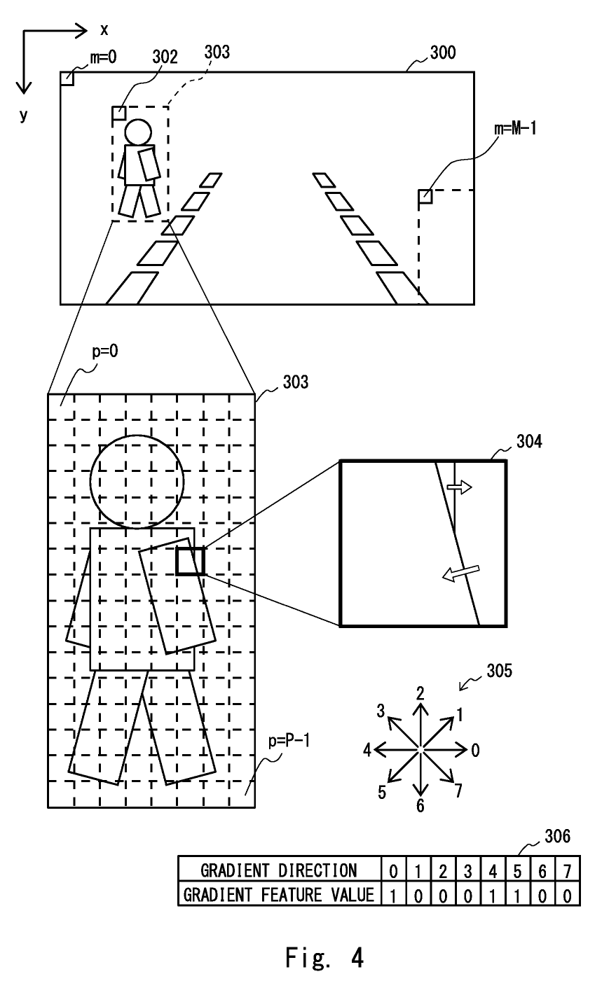

Next, a gradient feature value is explained with reference to FIG. 4. The gradient feature computation unit 120 calculates, for each block, brightness gradients for blocks adjacent to that block. Then, the gradient feature computation unit 120 separates the gradient vector into a gradient direction that is obtained by approximating the direction of the gradient vector by a certain direction and a gradient feature value that is obtained by converting the magnitude of the gradient vector into a binary value.

An image 300 is image data obtained by capturing an image taken by a camera. The image 300 is divided into a plurality of blocks in advance. For example, a window 303 in the image 300 is divided into eight sections in an x-direction and divided into 16 sections in a y-direction. Therefore, the window 303 is composed of 128 blocks 304 in total. The number of pixels in each block 304 may be one or more than one.

When the gradient feature computation unit 120 calculates gradient feature values for a block 304, the gradient feature computation unit 120 calculates a difference between a brightness value of that block 304 and the brightness value of each of four blocks that are adjacent to that block 304 in the up, down, right, and left directions. Then, the gradient feature computation unit 120 determines whether or not the brightness-value differences in the pre-assigned gradient directions are larger than a predetermined threshold, and outputs the result in the form of binary data. For example, the gradient feature computation unit 120 calculates brightness gradients each of which is approximated by a respective one of the example gradient directions 305 from the calculated brightness-value differences. In the shown example, it is assumed that the brightness-value difference in the direction 0 in the block 304 is larger than the predetermined threshold. In this case, the gradient feature computation unit 120 outputs a value “1” as a gradient feature value in the gradient direction 0 in the block 304. The gradient feature computation unit 120 performs the calculation for every gradient direction and outputs values shown in a table 306 as gradient feature values of the block 304. In the shown example, a gradient feature value output for one block has eight bits.

Because the gradient feature computation unit 120 outputs gradient feature values in the form of binary data, the calculation of co-occurrence feature values, which is performed after the above-described process, can be performed by simple logical calculation. As a result, the processing speed of the image recognition apparatus 100 can be increased.

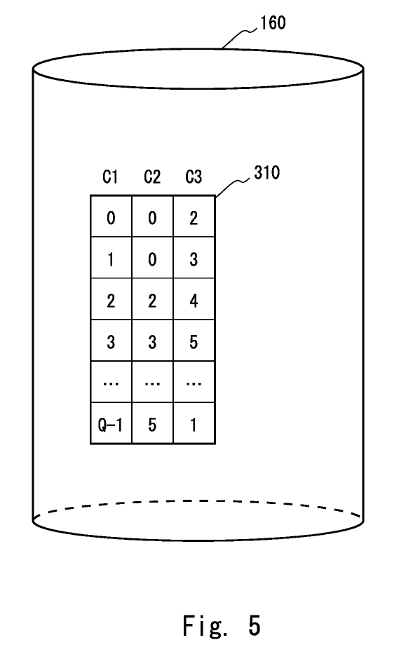

Next, a configuration of the combination dictionary 160 is explained with reference to FIG. 5. The combination dictionary 160 stores a plurality of pairs of gradient directions that are used to determine whether or not an image to be recognized is included are stored. A table 310 is an example of a structure of the combination dictionary 160. A pattern number C1 represents numbers assigned to Q combination patterns, respectively. The pattern number C1 is incremented from zero one by one and the last pattern number is Q−1. A selection part C2 stores gradient directions that are output to the bit selection units 1a to Pa of the co-occurrence feature computation unit 131. A selection part C3 stores gradient directions that are output to the bit selection units 1b to Pb, which are paired with the bit selection units 1a to Pa to which the gradient directions output from the selection part C2. In the shown example, in the case of the pattern number 0, the gradient direction output to the bit selection unit 1a is 0 and the gradient direction output to the bit selection unit 1b is 2.

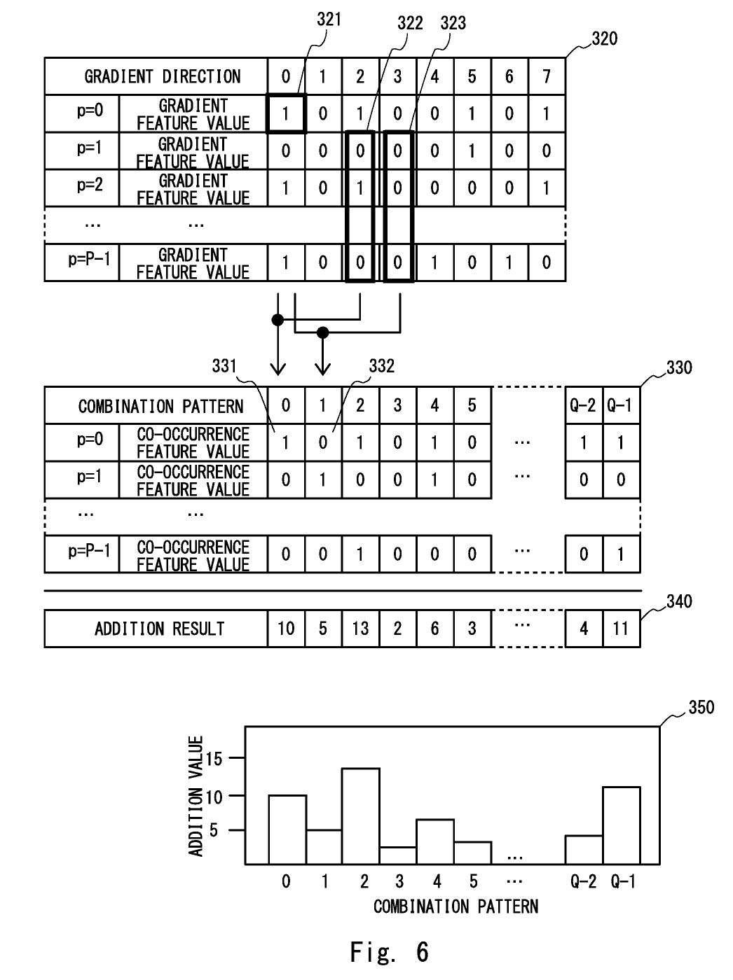

Next, calculation performed by the window calculation unit 180 is explained with reference to FIG. 6. A table 320 stores gradient feature values in each block in the window 303. A table 330 stores calculation results that the co-occurrence feature computation unit has obtained by calculating co-occurrence feature values from the gradient feature values in the table 320. A table 340 stores addition results that the arithmetic computation unit 132 has obtained by adding the calculation result in the table 330 for each combination pattern. A graph 350 shows statistical data that the statistical data generation unit 140 generates from the addition results in the table 340.

The co-occurrence feature computation unit 131 refers to the combination dictionary 160 shown in FIG. 5 and selects a value that is input to each bit selection unit from the table 320. Further, the co-occurrence feature computation unit 131 calculates co-occurrence feature values for blocks p=0 to p=P−1. That is, the co-occurrence feature computation unit 131 first refers to the combination dictionary 160 and calculates a co-occurrence feature value for the block p=0. The co-occurrence feature computation unit 131 refers to the pattern number 0 and the selection part C2 (i.e., refers to a cell in the first row and the second column in the table 310) in the combination dictionary 160. The value of the selection part C2 in the pattern number 0 is 0. Therefore, the co-occurrence feature computation unit 131 supplies a gradient feature value corresponding to the gradient direction 0 in the block p=0 to the bit selection unit 1a. That is, the co-occurrence feature computation unit 131 supplies a value “1”, i.e., the value of the gradient feature value 321 in the table 320. Next, the co-occurrence feature computation unit 131 refers to the selection part C3 corresponding to the selection part C2 of the pattern number 0 (i.e., refers to a cell in the first row and the third column in the table 310). The value of the selection part C3 in the pattern number 0 is 2. Therefore, the co-occurrence feature computation unit 131 successively supplies gradient feature values corresponding to the gradient direction 2 in the blocks p=1 to p=P−1 to the bit selection unit 1b. That is, the co-occurrence feature computation unit 131 successively supplies the values of the gradient feature value 322 in the table 320 to the bit selection unit 1b. In the shown example, the gradient feature value in the gradient direction 2 in the block p=2 is 1. Therefore, the logical multiplication of the bit selection units 1a and 1b becomes 1. The co-occurrence feature computation unit 131 outputs a value “1” as the co-occurrence feature value of the combination pattern 0 in the block p=0. In the shown example, “1” is shown in the value 331 in the table 330.

Similarly, the co-occurrence feature computation unit 131 calculates a co-occurrence feature value of the combination pattern 1 in the block p=0. The value of the selection part C2 of the pattern number 1 in the combination dictionary 160 is 0. Therefore, the co-occurrence feature computation unit 131 supplies a value “1”, i.e., the gradient feature value in the gradient direction 0 in the block p=0 to the bit selection unit 2a. Next, the co-occurrence feature computation unit 131 supplies a gradient feature value to the bit selection unit 2b. The value of the selection part C3 corresponding to the selection part C2 of the pattern number 1 is 3. Therefore, the co-occurrence feature computation unit 131 successively supplies gradient feature values corresponding to the gradient direction 3 in the blocks p=1 to p=P−1 to the bit selection unit 2b. That is, the co-occurrence feature computation unit 131 successively supplies the values of the gradient feature value 323 in the table 320 to the bit selection unit 2b. In the shown example, there is no block whose gradient feature value in the gradient direction 3 is 1 in the range of the blocks p=0 to p=P−1. Therefore, the logical multiplication of the bit selection units 2a and 2b becomes 0. The co-occurrence feature computation unit 131 outputs a value “0” to the co-occurrence feature value of the combination pattern 0 in the block p=0. In the shown example, “0” is shown in the value 332 in the table 330.

The co-occurrence feature computation unit 131 calculates co-occurrence feature values of all the combination patterns in the block p=0 in a similar manner. After completing the calculation of all the co-occurrence feature values in the block p=0, the co-occurrence feature computation unit 131 increments the block number. Then, the co-occurrence feature computation unit 131 repeats the above-described calculation up to the block p=P−1. By doing so, the co-occurrence feature computation unit 131 calculates co-occurrence feature values of all the combination patterns in all the blocks in the window. Then, the co-occurrence feature computation unit 131 outputs the values shown in the table 330 to the arithmetic computation unit 132.

The arithmetic computation unit 132 adds data received from the co-occurrence feature computation unit 131 for each combination pattern. Then, the arithmetic computation unit 132 outputs the addition results shown in table 340 to the statistical data generation unit 140.

The statistical data generation unit 140 generates statistical data based on the data received from the arithmetic computation unit 132. Specifically, the statistical data generation unit 140 combines values in each column and thereby generates data which is expressed in the form of a histogram as shown in the graph 350. Then, the statistical data generation unit 140 outputs the generated statistical data to the image recognition computation unit 150 as an output of the window calculation unit 180.

In the shown example, the window 303 is divided into 128 blocks and the number of gradient directions is eight, i.e., gradient directions 0 to 7. Therefore, if the image recognition apparatus 100 calculates all the co-occurrence feature values, which are expressed by combinations of all the gradient directions, for all the blocks in the window 303, the image recognition apparatus 100 needs to perform calculations for an enormous number of combinations. However, when the image recognition apparatus 100 selectively performs calculation based on values in the combination dictionary 160, the image recognition apparatus 100 can perform the process in a short time.

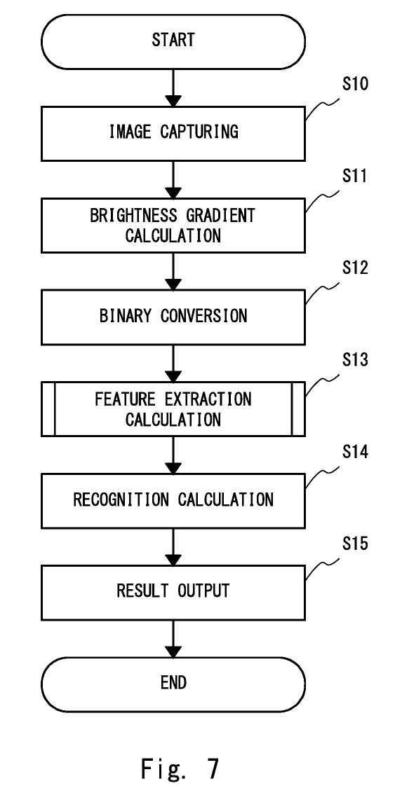

Next, an outline of a process performed by the image recognition apparatus 100 is explained with reference to FIG. 7. Firstly, the image recognition apparatus 100 captures an image 300, which is divided into a plurality of blocks, and supplies it to the gradient feature computation unit 120 (step S10).

The gradient feature computation unit 120 calculates the brightness gradients explained above with reference to FIG. 4 (step S11). Then, the gradient feature computation unit 120 converts the brightness gradients into binary data (step S12) and outputs the binary data to the window calculation unit 180.

The window calculation unit 180 performs feature extraction calculation based on the input binary data (step S13). Then, the window calculation unit 180 outputs generated statistical data to the image recognition computation unit 150. The image recognition computation unit 150 receives the statistical data output from the window calculation unit 180 and perform calculation for recognize (i.e., determine) whether or not an image to be recognized is included within the window (step S14). Then, the image recognition computation unit 150 outputs the calculation result to the outside of the image recognition apparatus 100 (step S15). For example, the image recognition computation unit 150 can output a value “1” when the image to be recognized is included within the window and output a value “0” when the image to be recognized is not included within the window.

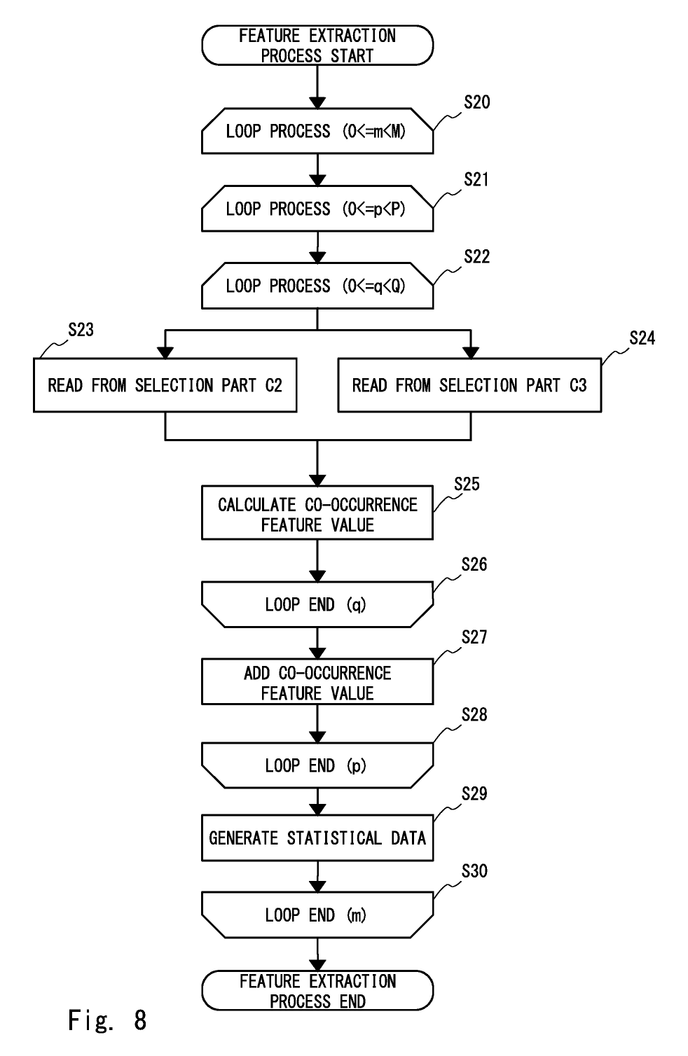

Next, a feature extraction calculation process performed by the window calculation unit 180 is explained with reference to FIG. 8. As shown in FIG. 4, the window calculation unit 180 repeats a feature extraction calculation process while successively moving the position of the block 302, which is the start point, and thereby moving the window 303 having a predetermined size. In the example shown in FIG. 4, the block 302, which is the start point, is a block located at the upper-left corner of the window 303. The window calculation unit 180 performs a loop process in which the block 302 is repeatedly and successively moved in the x- and y-directions from a position of a block m=0 to a position of a block m=M−1 at which the window reaches the lower-right corner (step S20).

After determining the position of the window 303, the co-occurrence feature computation unit 131 performs a loop process in which the position of the block 304 in the window 303 is successively determined (step S21). In the shown example, the block number is successively incremented from the block p=0 to the block p=P−1.

After determining the position of the block 304, the co-occurrence feature computation unit 131 calculates co-occurrence feature values in each block. The co-occurrence feature computation unit 131 selects a gradient direction by referring to the combination dictionary 160. The combination dictionary 160 stores combination patterns from a pattern number 0 to a pattern number Q−1. Note that Q is an integer no less than two. The co-occurrence feature computation unit 131 performs a loop process in each block in which the co-occurrence feature computation unit 131 successively reads combination patterns stored in the combination dictionary 160 (step S22). The co-occurrence feature computation unit 131 reads a gradient direction in the selection part C2 based on a q-th combination pattern (step S23) and reads a gradient direction in the selection part C3 corresponding to the selection part C2 (step S24). Then, the co-occurrence feature computation unit 131 calculates a logical multiplication of these gradient directions in a logical computation unit q and outputs a co-occurrence feature value for each combination pattern (step S25). The co-occurrence feature computation unit 131 repeats the above-described process until q becomes equal to Q−1 (i.e., q=Q−1), and then finishes the loop process (step S26).

The arithmetic computation unit 132 receives binary data, i.e., the co-occurrence feature values output by the co-occurrence feature computation unit 131, adds the co-occurrence feature values in a p-th block for each combination pattern, and outputs the addition result to the statistical data generation unit 140 (step S27). The arithmetic computation unit 132 repeats the above-described process until p becomes equal to P−1 (i.e., p=P−1), and then finishes the loop process (step S28).

The statistical data generation unit 140 receives the data output by the arithmetic computation unit 132, generates statistical data, and outputs the generated statistical data to the image recognition computation unit 150 (step S29). The window calculation unit 180 repeats the above-described process until m becomes equal to M−1 (i.e., m=M−1), and then finishes the loop process (step S30).

As explained above, it is possible to selectively calculate gradient feature values within the window by calculating co-occurrence feature values based on the combination dictionary and thereby to provide an image recognition apparatus that exhibits high detection performance in a short processing time.

### Second Embodiment

Next, a second embodiment is explained. The second embodiment is similar to the first embodiment except that information stored in a combination dictionary 161 differs from that stored in the combination dictionary 160. Therefore, explanations of the same matters, i.e., matters other than this difference are omitted.

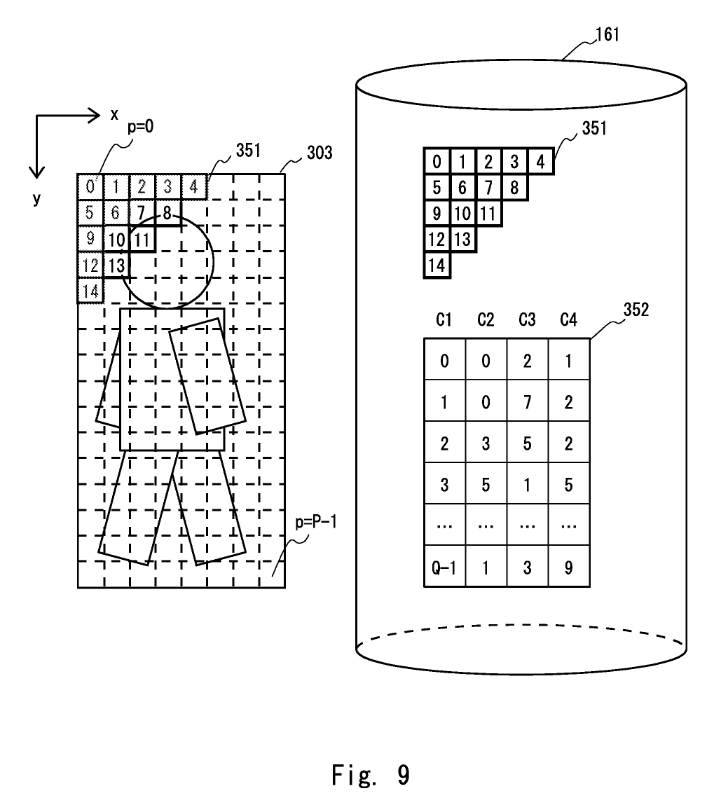

FIG. 9 is a diagram for explaining the combination dictionary 161 according to the second embodiment. The combination dictionary 161 differs from the combination dictionary 160 according to the first embodiment in that the combination dictionary 161 includes information about relative positions of blocks in addition to the information included in the combination dictionary 160. Relative position information 351 of blocks indicates that address numbers 0 to 14 are arranged in a positional relation as shown in the figure. The relative position information 351 indicates positions of other bocks relative to one selected block whose position is represented by an address number “0”. For example, when a co-occurrence feature value in a block p=0 is to be calculated, an address number “1” indicates a block that is adjacent to the selected block in the x-direction. A table 353 includes a combination pattern number C1, a selection part C2, a selection part C3, and position information C4. In the example shown in FIG. 9, the combination dictionary 161 includes the relative position information 351 and the table 352 as described above.

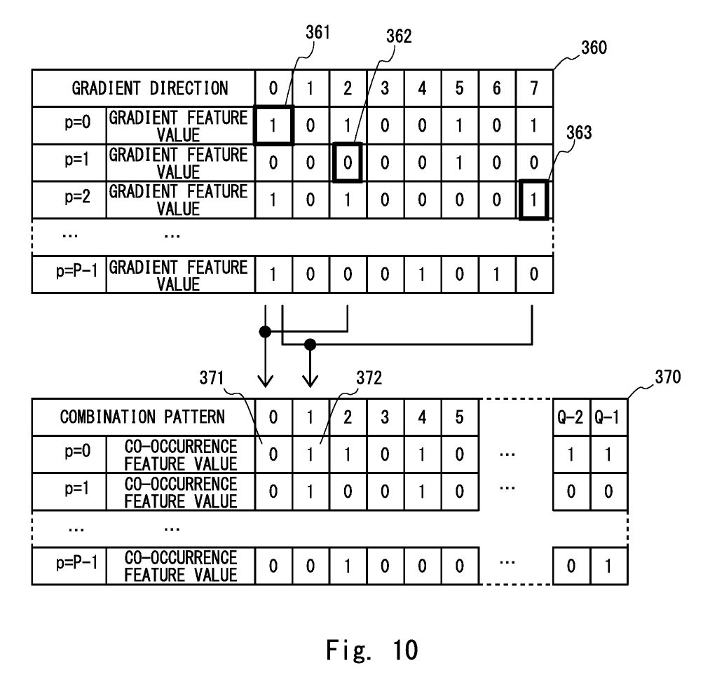

Next, calculation performed by window calculation unit 180 according to the second embodiment is explained with reference to FIG. 10. A table 360 stores gradient feature values in each block in the window 303. A table 370 stores calculation results that the co-occurrence feature computation unit has obtained by calculating co-occurrence feature values from the gradient feature values in the table 360.

The co-occurrence feature computation unit 131 refers to the combination dictionary 161 shown in FIG. 9 and selects a value that is input to each bit selection unit from the table 360. Further, the co-occurrence feature computation unit 131 calculates co-occurrence feature values for blocks p=0 to p=P−1. That is, the co-occurrence feature computation unit 131 first refers to the combination dictionary 161 and calculates a co-occurrence feature value for the block p=0. The co-occurrence feature computation unit 131 refers to the pattern number 0 and the selection part C2 in the combination dictionary 161. The value of the selection part C2 in the pattern number 0 is 0. Therefore, the co-occurrence feature computation unit 131 supplies a gradient feature value corresponding to the gradient direction 0 in the block p=0 to the bit selection unit 1a. That is, the co-occurrence feature computation unit 131 supplies a value “1”, i.e., the value of the gradient feature value 361 in the table 360. Next, the co-occurrence feature computation unit 131 refers to the selection part C3 corresponding to the selection part C2 of the pattern number 0. The value of the selection part C3 in the pattern number 0 is 2. Next, the co-occurrence feature computation unit 131 refers to the selection part C4 of the pattern number 0. The value of the selection part C4 in the pattern number 0 is 1. Therefore, the co-occurrence feature computation unit 131 selects a value “2”, i.e., the value of the selection part C3 for the gradient direction and selects a value “1”, i.e., the value of the selection part C4 for the address number. As a result, the co-occurrence feature computation unit 131 supplies the value of the gradient direction 2 in the block p=1 to the bit selection unit 1b. That is, the co-occurrence feature computation unit 131 supplies a value “0”, i.e., the value of the gradient feature value 362 in the table 360. Therefore, since the bit selection unit 1a becomes 1 and the bit selection unit 1b becomes 0, their logical multiplication becomes 0. In the shown example, “0” is shown in the value 371 in the table 370.

Similarly, the co-occurrence feature computation unit 131 calculates a co-occurrence feature value of the combination pattern number 1 in the block p=0. The value of the selection part C2 in the pattern number 1 is 0. Therefore, the co-occurrence feature computation unit 131 supplies a gradient feature value corresponding to the gradient direction 0 in the block p=0 to the bit selection unit 1a. That is, the co-occurrence feature computation unit 131 supplies a value “1”, i.e., the value of the gradient feature value 361 in the table 360. Next, the co-occurrence feature computation unit 131 refers to the selection part C3 of the pattern number 1. The value of the selection part C3 in the pattern number 1 is 7. Next, the co-occurrence feature computation unit 131 refers to the selection part C4 of the pattern number 1. The value of the selection part C4 in the pattern number 1 is 2. Therefore, the co-occurrence feature computation unit 131 selects a value “7”, i.e., the value of the selection part C3 for the gradient direction and selects a value “2”, i.e., the value of the selection part C4 for the address number. As a result, the co-occurrence feature computation unit 131 supplies the value of the gradient direction 7 in the block p=2 to the bit selection unit 1b. That is, the co-occurrence feature computation unit 131 supplies a value “1”, i.e., the value of the gradient feature value 363 in the table 360. Therefore, since the bit selection unit 1a becomes 1 and the bit selection unit 1b becomes 1, their logical multiplication becomes 1. In the shown example, “1” is shown in the value 372 in the table 370. The explanation of the subsequent processes is similar to that in the first embodiment and hence is omitted here.

As explained above, it is possible to selectively calculate gradient feature values within the window by calculating co-occurrence feature values based on the combination dictionary with the position information incorporated therein and thereby to provide an image recognition apparatus that exhibits high detection performance in a short processing time. Note that the specific method for storing the combination dictionary and the range of address information are not limited to those explained above. That is, they can be implemented in various patterns.

### Third Embodiment

Prior to explaining details of a third embodiment, an outline of a technical background of the third embodiment is explained.

It is possible to improve the recognition accuracy by performing additional image processing in addition to the image processing performed by the image recognition apparatus described in the first or second embodiment. For example, the size of an image to be recognized included in a captured image is not constant. Therefore, it is possible to improve the recognition performance by converting a relative size of the image with respect to the window. Further, it is possible to increase the processing speed by removing image data of a part (s) which is extremely unlikely to include any image to be recognized in advance. Further, it is possible to increase the processing speed by increasing the shifting width by which the position of the window is changed at each step and then performing a feature value extraction process again for an area near the window which is likely to include an image to be recognized while shifting the window by a small shifting width.

Further, it is possible to improve the recognition accuracy by adding up or adding a weighting value that is learned in advance to the calculated statistical data. As an example of such a weighting technique, a technique using an SVM (Support Vector Machine) has been known. For example, when: a recognition model of a discrimination unit is represented by f(x); a feature vector is represented by x=[x1, x2, . . . ]; a weighting vector is represented by w=[w1, w2, . . . ]; and a bias is represented by b, their relation is expressed as “f(x)=wTx+b”. It is possible to determine that it is an object to be recognized when the function f(x) has a positive value, and that it is not an object to be recognized when the function f(x) has a negative value. By using this technique, the recognition performance of the image recognition apparatus can be improved.

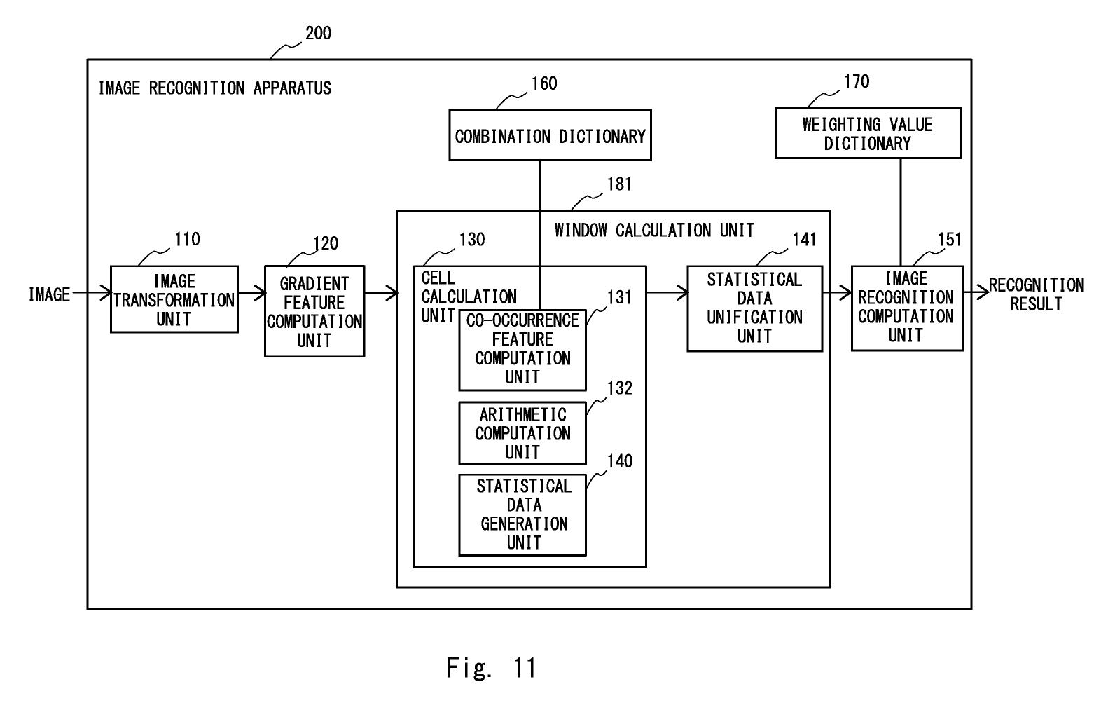

Next, an image recognition apparatus 200 according to the third embodiment is explained. FIG. 11 is a functional block diagram according to the third embodiment. Only the differences from the first embodiment are explained hereinafter and explanations of the same parts are omitted.

The image recognition apparatus 200 includes an image transformation unit 110 and a weighting value dictionary 170 in addition to the components of the image recognition apparatus 100 according to the first embodiment. Further, the window calculation unit 181 includes a cell calculation unit 130 and a statistical data unification unit 141. The cell calculation unit 130 includes a co-occurrence feature computation unit 131, an arithmetic computation unit 132, and a statistical data generation unit 140. The gradient feature computation unit 120, the co-occurrence feature computation unit 131, the arithmetic computation unit 132, the statistical data generation unit 140, and the combination dictionary 160 are similar to those in the first embodiment and hence their explanations are omitted.

The image transformation unit 110 captures image data, performs predetermined image transformation processing, and outputs the processed image data to the gradient feature computation unit 120.

The window calculation unit 181 divides the windows into a plurality of cells and generates statistical data for each of the cells. Then, the window calculation unit 181 unifies the statistical data for each cell within the windows and outputs the unified statistical data to the image recognition computation unit 151. The unified statistical data is, for example, co-occurrence feature values within the window expressed in the form of a histogram.

The image recognition computation unit 151 receives data output from the statistical data unification unit 141 and performs image recognition calculation while referring to data in the weighting value dictionary 170. For example, a support vector machine can be used for the weighting calculation. The image recognition computation unit 151 determines whether or not an image to be recognized is included in the image based on the calculation result and outputs the determination result to the outside of the image recognition apparatus 200.

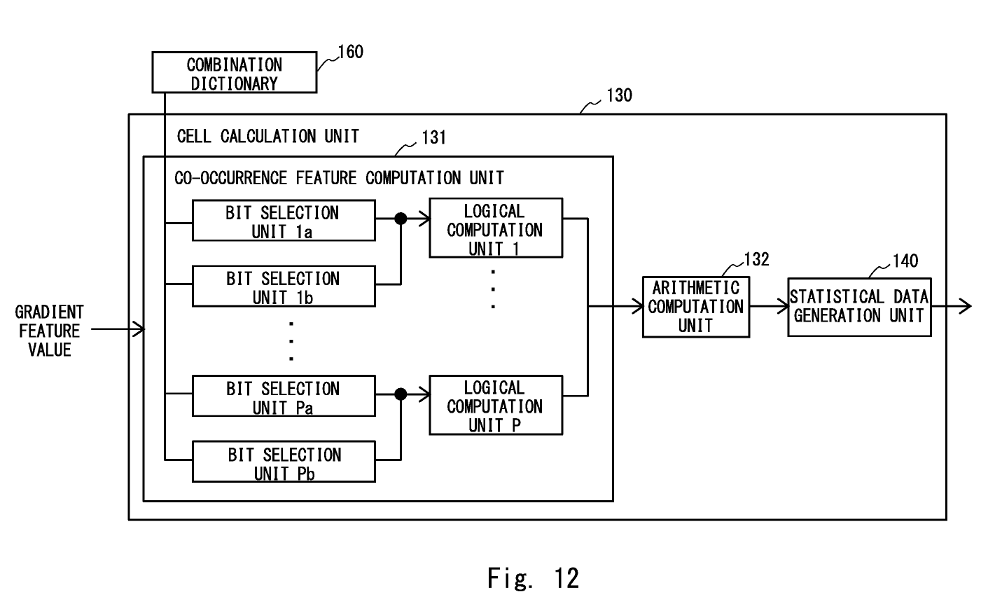

Next, details of the cell calculation unit 130 are explained with reference to FIG. 12. The cell calculation unit 130 receives bias data for gradient feature values from the gradient feature computation unit 120 and supplies it to the co-occurrence feature computation unit 131. The functions of the co-occurrence feature computation unit 131, the arithmetic computation unit 132, and the statistical data generation unit 140 are similar to those explained in the first embodiment. However, the data processed in the cell calculation unit 130 is data within a cell, which is formed by dividing the window. The statistical data generation unit 140 generates statistical data based on the image data within the cell and outputs the generated statistical data to the statistical data unification unit 141.

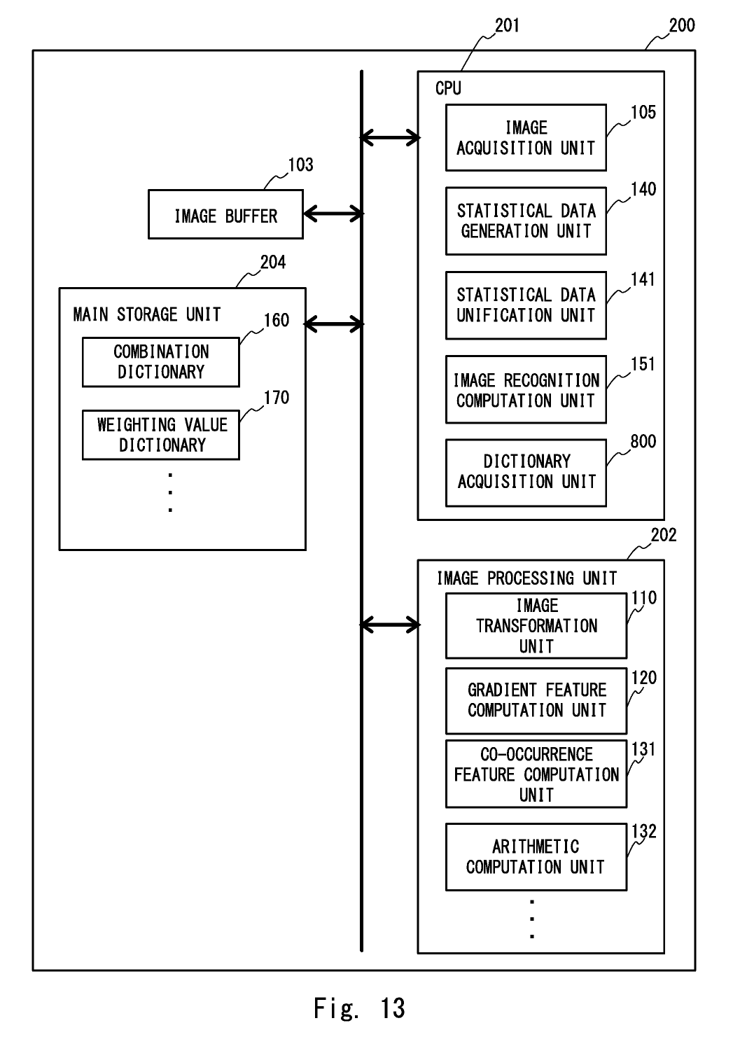

Next, a hardware configuration of the image recognition apparatus 200 is explained with reference to FIG. 13. Note that explanations of the same parts as those of the image recognition apparatus 100 according to the first embodiment are omitted.

The image recognition apparatus 200 includes a CPU 201, an image processing unit 202, an image buffer 103, and a main storage unit 204. These components are connected to each other through a communication bus. The CPU 201 includes an image acquisition unit 105, a statistical data generation unit 140, a statistical data unification unit 141, an image recognition computation unit 151, and a dictionary acquisition unit 800. The image processing unit 202 includes an image transformation unit 110, a gradient feature computation unit 120, a co-occurrence feature computation unit 131, and an arithmetic computation unit 132. The main storage unit 204 includes a combination dictionary 160 and a weighting value dictionary 170.

Next, the combination dictionary 160 and the weighting value dictionary 170 stored in the main storage unit 204 are explained. The combination dictionary 160 and the weighting value dictionary 170 are generated by making a learning unit capture (i.e., receive) object image data that is to be recognized and non-object data that is not to be recognized, and perform learning in advance.

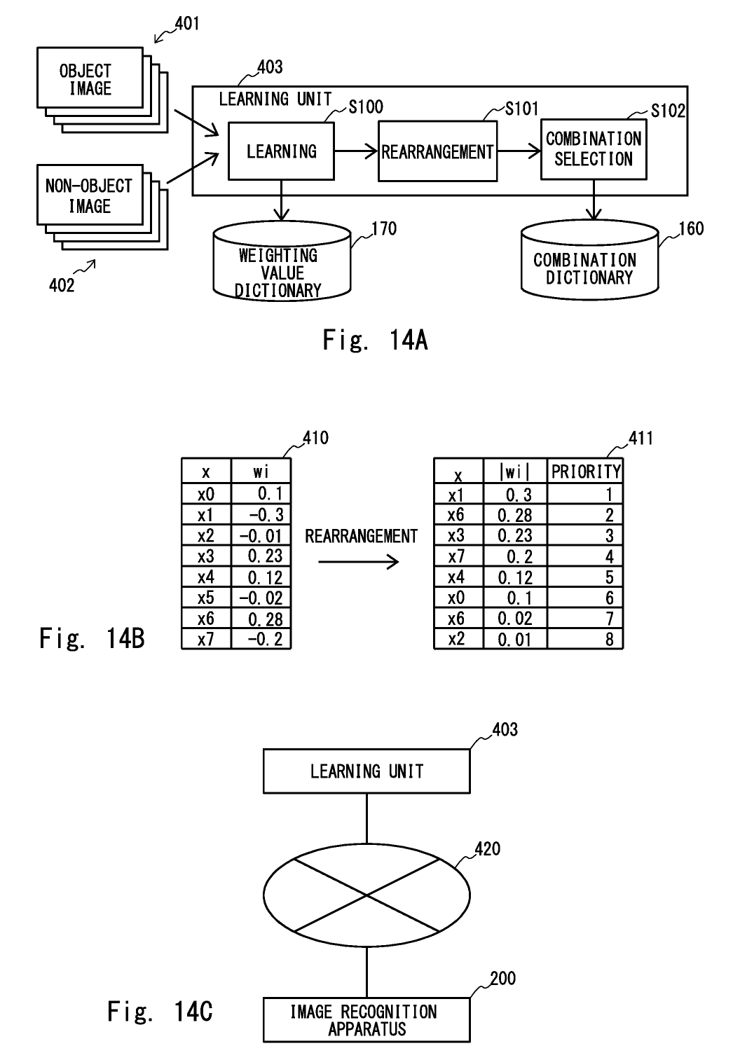

FIG. 14A is a diagram for explaining a method for generating a weighting value dictionary and a combination dictionary. This method is, for example, performed by a computer, or an apparatus equipped with a learning unit for executing a desiccated program. Object images 401 are a plurality of image data of images each of which is obtained by photographing an object to be recognized. Non-object images 402 are a plurality of image data of images each of which is obtained by photographing an object other than the object to be recognized. The object images 401 and the non-object images 402 are input to the learning unit 403.

The learning unit 403 receives the object images 401 and the non-object images 402, calculates gradient feature values for each of them, and learns features of the object images and those of the non-object images based on the calculated data (S100). Then, the learning unit 403 outputs the learning results as values of the weighting value dictionary 170. In the case where the weighting value dictionary 170 adopts an SVM, the learning unit 403 outputs weighing vectors wi and biases b to the weighting value dictionary 170. When the learning is appropriately performed, feature vectors wi related to the object images have positive values and feature vectors wi related to the non-object images have negative values. Further, feature vectors wi that are related to neither of them have values close to zero. The absolute values of feature vectors wi are determined based on their likelihoods (i.e., degrees of accuracy). For example, a feature vector wi that is universally (i.e., always) detected in object images and rarely detected in non-object images has a positive value and its absolute value is relatively large.

Next, the learning unit 403 rearranges (i.e., sorts) the calculated data according to the priority (step S101). FIG. 14B is a diagram for explaining a rearrangement of feature vectors according to the third embodiment. The learning unit 403 rearranges the gradient feature values of the object images in descending order of priority and derives co-occurrence gradient feature values from the rearranged gradient feature values. For example, the learning unit 403 rearranges the data by regarding (i.e., using) the magnitudes of the absolute values of weighting vectors wi as priority levels. Specifically, in the learning unit 403, a feature vector is expressed as “x=[x0, x2, . . . , x7]”. In this case, the values of the weighting vectors wi are set to, for example, values shown in a table 410. The learning unit 403 calculates the absolute values of the weighting vectors wi and rearranges the data in descending order of their absolute values. As a result of the rearrangement, as shown in a table 411, the weighting vector wi of a feature vector x1 has the largest value and hence the highest priority.

Next, the learning unit 403 selects a combination of co-occurrence gradient feature values (step S102). The learning unit 403 outputs the selected combination to the combination dictionary 160 and finishes the process.

Note that the learning unit 403 may successively update the combination dictionary 160 and the weighting value dictionary 170. For example, as shown in FIG. 14C, the learning unit 403 and the image recognition apparatus 200 are located apart from each other and connected with each other through a network 420. When the learning unit 403 captures a new image and the combination dictionary 160 or the weighting value dictionary 170 is updated, the dictionary data is sent to the image recognition apparatus 200 through the network 420. Upon receiving the new dictionary data, the image recognition apparatus 200 updates the combination dictionary 160 or the weighting value dictionary 170.

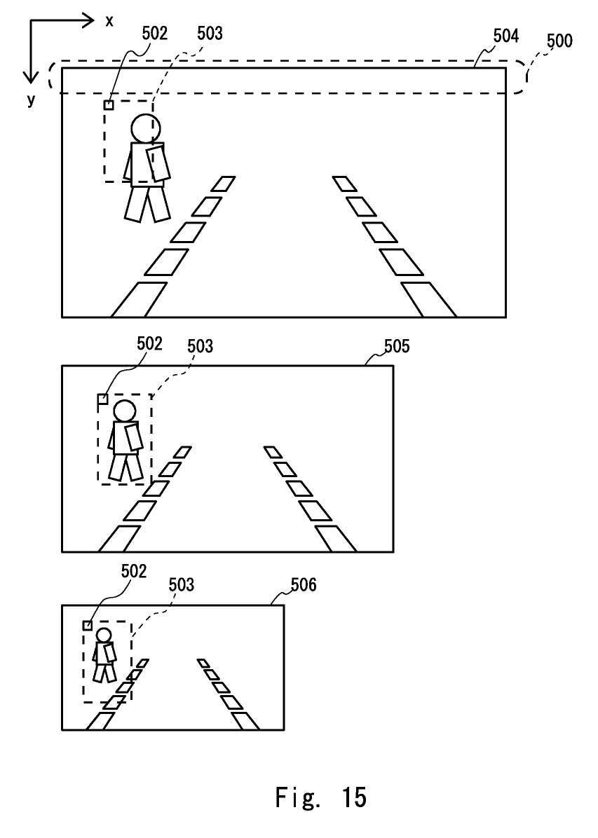

Next, the image transformation unit 110 is explained with reference to FIG. 15. The image transformation unit 110 performs a transformation process for a captured image. For example, the image transformation unit 110 receives an image 504 and performs a transformation process for reducing the size of the image. In the shown example, the image transformation unit 110 generates reduced images 505 and 506. The number of pixels constituting the image 505 is smaller than the number of pixels constituting the image 504. Further, the number of pixels constituting the image 506 is smaller than that of the image 505.

Note that the size of the window 503 defined by the window calculation unit 181 is constant (i.e., unchanged) for all the images 504 to 506. Therefore, as shown in FIG. 15, the window 503 makes it possible to recognize an image having a relatively different size for a reduced image.

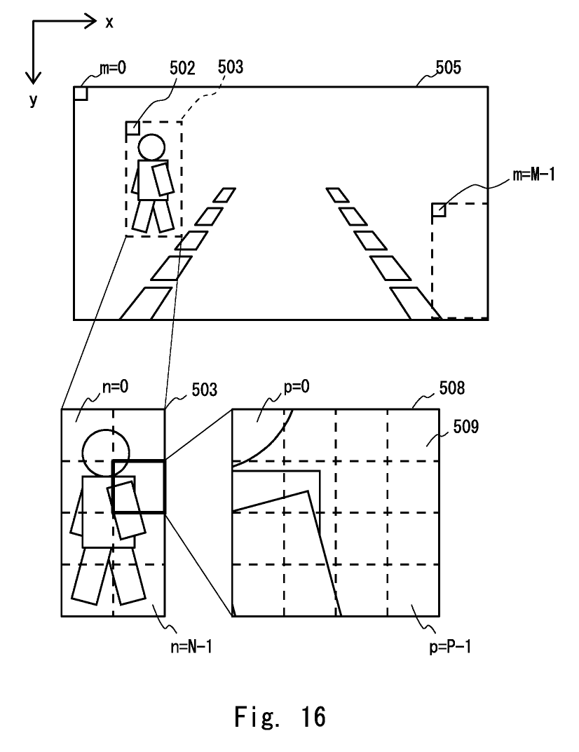

Next, cells 508 are explained with reference to FIG. 16. The image recognition apparatus 200 performs an image recognition process while moving the window 503 with respect to the captured image 505. The window 503 consists of a plurality of cells 508. In the shown example, the window 503 consists of eight cells. Further, each of the cells 508 consists of a plurality of blocks 509. In the shown example, a cell 508 consists of 16 blocks 509.

By forming the window 503 by using a plurality of cells as described above, the recognition process can be performed on a cell-by-cell basis within the window 503.

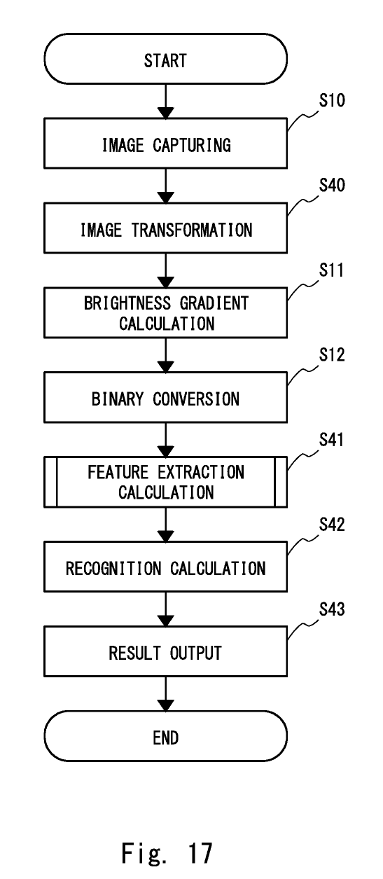

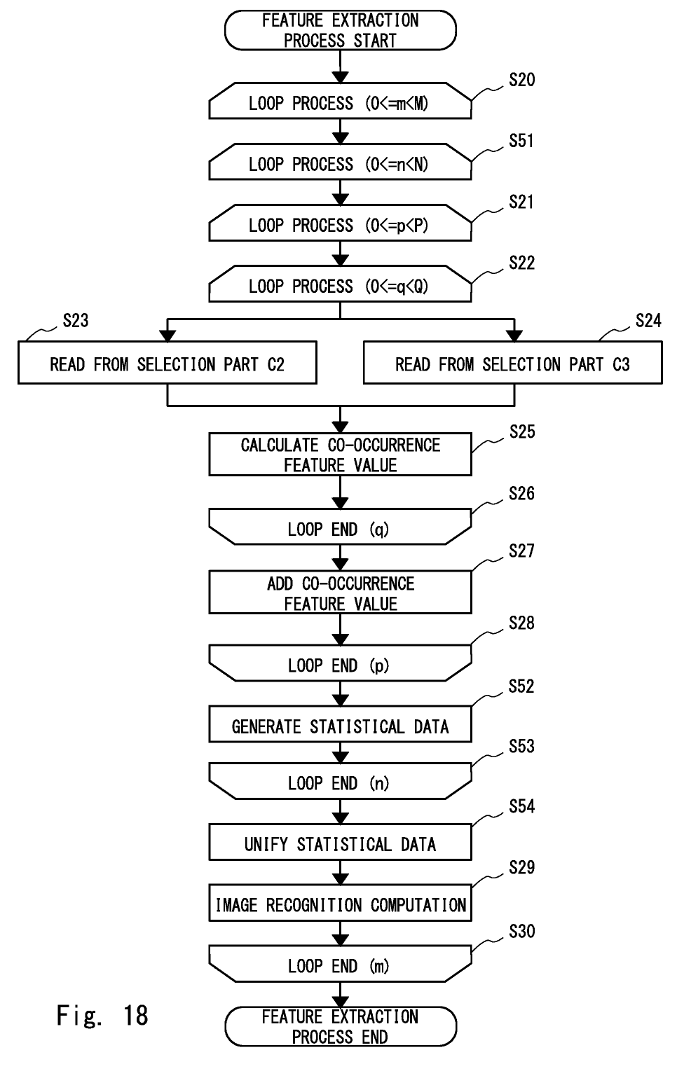

Next, an outline of a process performed by the image recognition apparatus 200 is explained with reference to FIGS. 17 and 18. FIG. 17 is a flowchart showing an example of a process performed by the image recognition apparatus 200. Explanations of the same processes as those explained above in the first embodiment are omitted. Firstly, the image recognition apparatus 200 captures an image 300 that is divided into a plurality of blocks and supplies the captured image to the image transformation unit 110 (step S10).

Next, the image transformation unit 110 performs a transformation process for the captured image (step S40). For example, the image transformation unit 110 performs a transformation process for reducing the size of the image as shown in FIG. 16.

Next, the image transformation unit 110 outputs the transformation-processed image data to the gradient feature computation unit 120. Processes in steps S11 and S12 are similar to those explained above in the first embodiment and hence explanations of them are omitted here. The gradient feature computation unit 120 outputs binary data, which is the calculation result, to the window calculation unit 181.

Next, the window calculation unit 181 performs feature extraction calculation based on the received binary data (step S41). The window calculation unit 181 outputs statistical data that is generated as a result of the calculation to the image recognition computation unit 151. The image recognition computation unit 151 receives the statistical data output by the window calculation unit 181 and performs discrimination calculation (step S42). Then, the image recognition computation unit 151 outputs the calculation result to the outside of the image recognition apparatus 200 (step S43).

Next, a specific example of a process performed by the image recognition computation unit 151 is explained. The image recognition computation unit 151 receives data output from the statistical data unification unit 141 and performs image recognition calculation. When doing so, the image recognition computation unit 151 refers to data in the weighting value dictionary 170. For example, an SVM can be used for the weighting calculation. For example, the below-shown value is output as a feature vector of the SVM from the statistical data unification unit 141.

x=[x1,x2, . . . ,xm]

For this feature vector, the weighting vector wi is defined, for example, as follows.

wi=[w1,w2, . . . ,wm]

Then, the following calculation is performed.
As a result of the calculation, when the function f(x) has a positive value, it means that the window includes an image to be recognized. Further, it means that the larger the value is, the more likely the image to be recognized is included.

Next, a feature extraction calculation process performed by the window calculation unit 181 is explained with reference to FIG. 18. Similarly to the first embodiment, the window calculation unit 181 repeats the feature extraction calculation process while moving the window 503. Note that as shown in FIG. 16, the window

$$f ( x ) = ( w 1 , w 2 , … , wm ) ( \begin{matrix}x 1 \\ x 2 \\ ⋮ \\ xm\end{matrix} ) + b$$

calculation unit 181 performs a loop process in which the block 503, which is the start point, is repeatedly and successively moved in the x- and y-directions from a position of a block m=0 to a position of a block m=M−1 (step S20).

After determining the position of the window, the cell calculation unit 130 performs a loop process in which the position of the cell 508 in the window 503 is successively determined (step S51). As shown in FIG. 16, the cell 508 is repeatedly moved from a position of a cell n=0 to a position of a cell n=N−1.

After determining the position of the cell, the co-occurrence feature computation unit 131 performs a loop process in which the position of the block 509 in the cell is successively determined (step S21). As shown in FIG. 16, the block 509 is repeatedly moved from a position of a block p=0 to a position of a block p=N−1.

After determining the position of the block, the co-occurrence feature computation unit 131 calculates co-occurrence feature values in each block. Note that the co-occurrence feature computation unit 131 performs calculation as to whether or not there is a co-occurrence feature value within the cell. Specifically, the calculation is similar to that explained above in the first embodiment and hence explanations of steps S22 to S26 are omitted here.

The arithmetic computation unit 132 receives binary data, i.e., the co-occurrence feature values output by the co-occurrence feature computation unit 131 and adds the co-occurrence feature values in a p-th block for each combination pattern (step S27). The arithmetic computation unit 132 repeats the above-described process until p becomes equal to P−1 (i.e., p=P−1), and then finishes the loop process (step S28).

The cell calculation unit 130 supplies the data output by the arithmetic computation unit 132 to the statistical data generation unit 140 and generates statistical data within the cell (step S52). The cell calculation unit 130 repeats the above-described process until n becomes equal to N−1 (i.e., n=N−1), and then finishes the loop process (step S53).

The window calculation unit 181 supplies the statistical data output by the cell calculation unit 130 to the statistical data unification unit 141 and unifies the statistical data (step S54). The window calculation unit 181 repeats the above-described process until m becomes equal to M−1 (i.e., m=M−1), and then finishes the loop process (step S30).

As explained above, by calculating co-occurrence feature values for the transformation-processed image based on the combination dictionary, it is possible to provide an image recognition apparatus that exhibits high detection performance in a short processing time.

In the third embodiment, since the window is divided into a plurality of cells, it is possible to perform different calculation for each cell. For example, the image recognition apparatus 200 can be equipped with a dictionary including combination patterns according to the positions of cells in the window. Further, the image recognition apparatus 200 can be equipped with a dictionary including weighting values according to the positions of cells in the window.

For example, assume that the purpose of the window 503 in FIG. 16 is to recognize (i.e., determine) whether or not a human being is included in the image. In such a case, it could be sufficient if the upper half of a human body can be recognized from, among the eight cells 508 included in the window 503, four cells 508 located in the upper part of the window 503. In such a case, a combination dictionary for recognizing the upper half of a human body may be used for co-occurrence feature values. Further, as for the weighting, weighting for recognizing the upper half of a human body may be performed.

Although the above-described processes may increase the storage capacities of the dictionaries, they make it possible to provide an image recognition apparatus that exhibits high detection performance in a shorter processing time.

Further, the image transformation unit 110 can perform a process for deleting a part (s) of the captured image that is unlikely to include an image to be recognized. In FIG. 15, the upper area 500 of the image 504 is unlikely to include a human being. Therefore, the image transformation unit 110 can perform a trimming for this part and output the trimmed image.

By doing so, it is possible to provide an image recognition apparatus that requires a shorter processing time.

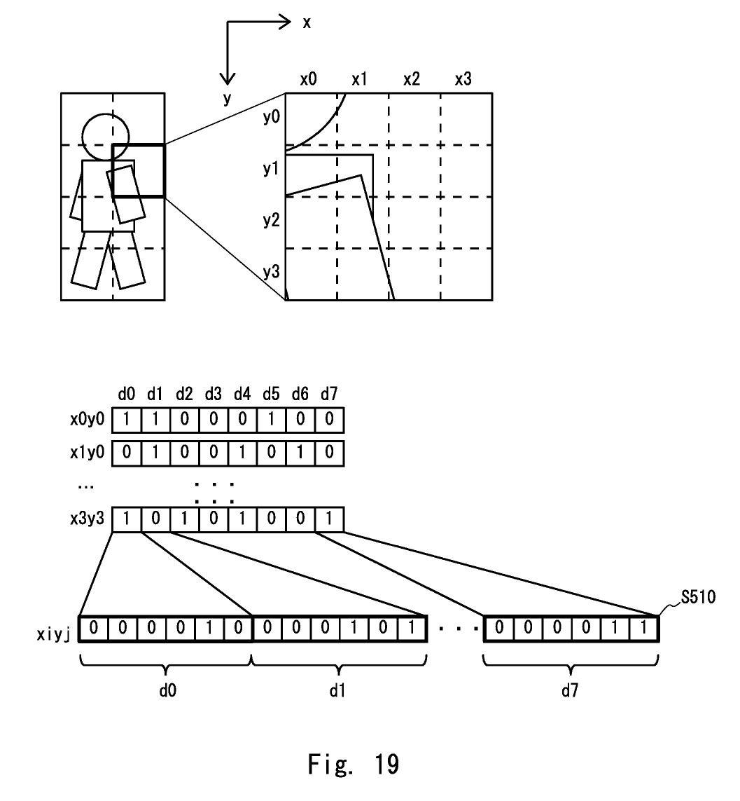

Further, the arithmetic computation unit 132 can be equipped with a computation unit capable of processing data whose bit length (i.e., the number of bits) is equal to or larger than a number obtained by adding up the sum total of the number of blocks within a cell and the sum total of the number of combination patterns of co-occurrence feature values. An example of the arithmetic computation unit 132 is explained with reference to FIG. 19. In FIG. 19, a window is divided into eight cells. Further, each cell is divided into 16 blocks. In this example, the number of combination patterns of co-occurrence feature values is eight, i.e., from d0 to d7. In this case, for co-occurrence feature values calculated for each block, at least eight bits are assigned to an x0y0 block and at least eight bits are assigned to an x1y0 block. In the shown example, when co-occurrence feature values are calculated for all the blocks within the cell, the addition result is 16 at the maximum. To express a number “16” in arithmetic calculation by binary data, a computation unit 510 whose bit length is five or longer is sufficient. To provide five bits or more for each of the eight combination patterns, the computation unit 510 needs at least 40 bits. That is, the computation unit 510 of the arithmetic computation unit 132 includes a bit array of at least 40 bits. Further, when the arithmetic computation unit 132 adds these data, the arithmetic computation unit 132 does not successively calculate co-occurrence feature values of each combination pattern in each block. Instead, as shown in an xiyj block in FIG. 19, the arithmetic computation unit 132 is equipped with a computation unit 510 having a bit array of at least 40 bits (48 bits in the example shown in FIG. 19) and directly adds co-occurrence feature values to respective combination patterns.

Although the calculation performed by the above-described computation unit 510 requires a computation unit 510 having a larger number of digits, the number of calculation cycles performed by the arithmetic computation unit is reduced, thus making it possible to perform the calculation at a higher speed. As a result, it is possible to provide an image recognition apparatus that requires a shorter processing time.

Further, the image recognition apparatus 200 can perfume the step of moving the position of the window over multiple steps. In FIG. 16, the image recognition apparatus 200 extracts co-occurrence feature values while successively changing the position of the start-point block 502 and thereby successively moving the window 503. In this process, the start point is the block m=0 and it is moved, for example, by eight blocks at a time in the x-direction. Then, when the window reaches the right end of the image, it is moved by one block in the y-direction. That is, as a first window position, the image recognition apparatus 200 performs an image recognition process for the window that is moved by eight steps at a time in the x-direction. As a result of the image recognition process, the image recognition apparatus 200 determines a window that is likely to include an image to be recognized. Then, the image recognition apparatus 200 performs an image recognition process for a plurality of windows located at or near the window that has been determined to be likely to include the image to be recognized while changing the position of the window, for example, by one block at a time in the x-direction.

By performing the above-described process, it is possible to provide an image recognition apparatus that requires a shorter processing time.

### Fourth Embodiment

Next, an image recognition system according to a fourth embodiment is explained. Note that explanations of the same matters as those already explained above are omitted.

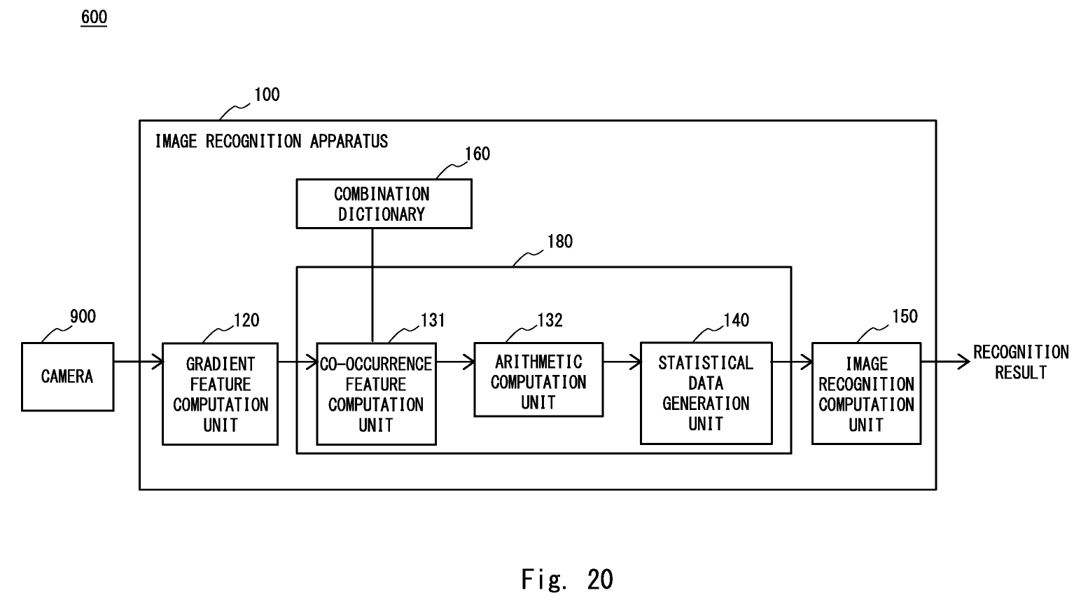

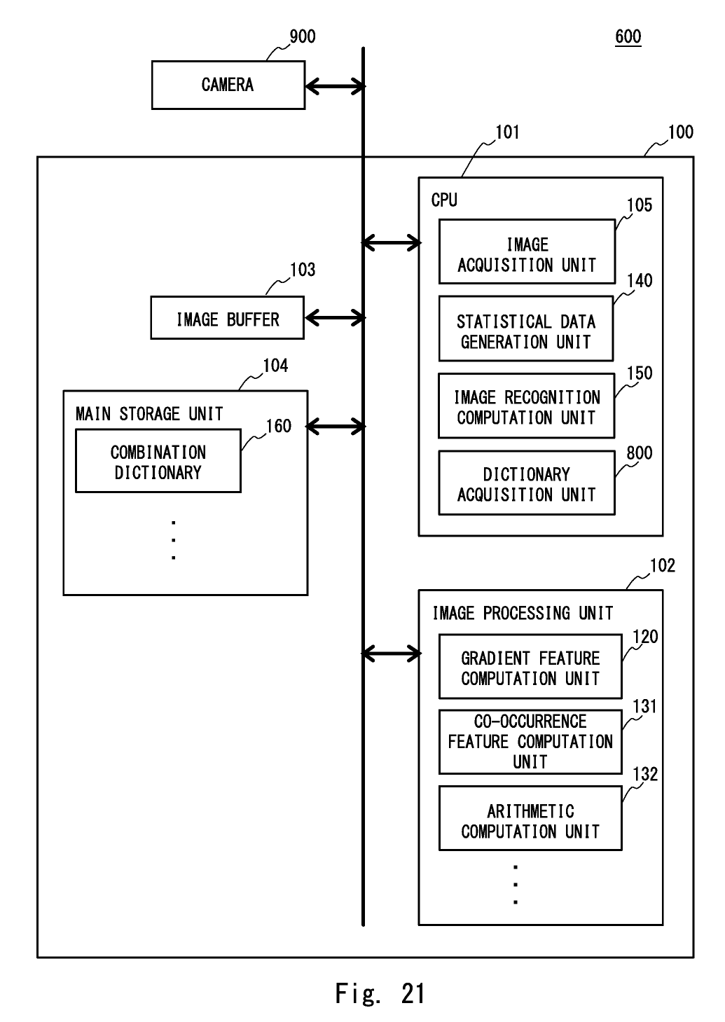

FIG. 20 is a functional block diagram of an image recognition system 600 according to the fourth embodiment. FIG. 21 shows a hardware configuration of the image recognition system 600 according to the fourth embodiment. As shown in FIGS. 20 and 21, the image recognition system 600 includes a camera 900 in addition to the components of the image recognition apparatus 100 according to the first embodiment. The camera 900 includes an image pickup device and a lens(s). When the camera 900 takes an image, it transmits the taken image to the image recognition apparatus 100. The camera 900 is connected to the CPU 101, the image processing unit 102, the image buffer 103, and the main storage unit 104 thorough a communication bus. The CPU 101 may include a control unit that controls the camera.

By the above-described system, it is possible to provide an image recognition system that exhibits high detection performance in a short processing time.

While the invention has been described in terms of several embodiments, those skilled in the art will recognize that the invention can be practiced with various modifications within the spirit and scope of the appended claims and the invention is not limited to the examples described above.

The whole or part of the embodiments disclosed above can be described as, but not limited to, the following supplementary notes.

### (Supplementary Note 1)

An image recognition apparatus comprising:

a gradient feature computation unit configured to calculate, from an image divided into a plurality of blocks, gradient feature values for each of the plurality of blocks;

a combination pattern storage unit configured to store a plurality of combination patterns of the gradient feature values;

a co-occurrence feature computation unit configured to calculate a co-occurrence feature value in a plurality of blocks for each of the plurality of combination patterns;

an arithmetic computation unit configured to calculate an addition value by adding the co-occurrence feature value for each of the plurality of combination patterns;

a statistical data generation unit configured to generate statistical data from the addition value; and

an image recognition computation unit configured to define a window having a predetermined size for the image and recognize whether or not a predetermined image is included in the window based on the statistical data within the window.

### (Supplementary Note 2)

The image recognition apparatus described in Supplementary note 1, wherein

the gradient feature value is composed of a direction of a brightness gradient and a magnitude of the brightness gradient, and

the magnitude of the brightness gradient is expressed by a binary value.

### (Supplementary Note 3)

The image recognition apparatus described in Supplementary note 1, wherein the combination pattern is a combination of a gradient feature value in a first block and a gradient feature value in a second block.

### (Supplementary Note 4)

The image recognition apparatus described in Supplementary note 3, wherein the combination pattern further includes information about a position of the second block relative to the first block.

### (Supplementary Note 5)

The image recognition apparatus described in Supplementary note 1, wherein

the window is divided into a plurality of cells, each of the plurality of cells including at least two blocks,

the statistical data generation unit generates statistical data for each of the plurality of cells, and

the image recognition apparatus further comprises a statistical data unification unit configured to unify the statistical data for each of the plurality of cells within the window.

### (Supplementary Note 6)

The image recognition apparatus described in Supplementary note 5, further comprising a weighting value storage unit configured to store a weighting value, wherein

the image recognition computation unit recognizes whether or not a predetermined image is included in the window based on the statistical data and the weighting value.

### (Supplementary Note 7)

The image recognition apparatus described in Supplementary note 6, wherein

a weighting vector and a bias of a support vector machine are stored in the weighting value storage unit, and

the image recognition computation unit comprises the support vector machine.

### (Supplementary Note 8)

The image recognition apparatus described in Supplementary note 5, further comprising an image transformation unit configured to transform a captured image into a plurality of images having reduced sizes.

### (Supplementary Note 9)

The image recognition apparatus described in Supplementary note 6, wherein the combination pattern storage unit or the weighting value storage unit stores a combination pattern or a weighting value according to a position of the cell within the window.

### (Supplementary Note 10)

The image recognition apparatus described in Supplementary note 1, further comprising an image transformation unit configured to perform a trimming process for a captured image.

### (Supplementary Note 11)

The image recognition apparatus described in Supplementary note 5, wherein the arithmetic computation unit comprises a computation unit configured to process data whose bit length is equal to or longer than a number obtained by adding up a sum total of the number of blocks within the cell and the number of combination patterns of the co-occurrence feature value.

### (Supplementary Note 12)

An image recognition system comprising:

a camera;

a gradient feature computation unit configured to calculate, from an image divided into a plurality of blocks, gradient feature values for each of the plurality of blocks;

a combination pattern storage unit configured to store a plurality of combination patterns of the gradient feature values;

a co-occurrence feature computation unit configured to calculate a co-occurrence feature value in a plurality of blocks for each of the plurality of combination patterns;

an arithmetic computation unit configured to calculate an addition value by adding the co-occurrence feature value calculated for each of the plurality of blocks for each of the plurality of combination patterns;

a statistical data generation unit configured to generate statistical data from the addition value; and

an image recognition computation unit configured to define a window having a predetermined size for the image and recognize whether or not a predetermined image is included in the window based on the statistical data within the window.

### (Supplementary Note 13)

The image recognition system described in Supplementary note 12, wherein

the gradient feature value is composed of a direction of a brightness gradient and a magnitude of the brightness gradient, and

the magnitude of the brightness gradient is expressed by a binary value.

### (Supplementary Note 14)

An image recognition method performed by an image recognition apparatus, comprising:

calculating, from an image divided into a plurality of blocks, gradient feature values for each of the plurality of blocks;

reading a combination pattern of the gradient feature value from a storage unit storing a plurality of combination patterns of the gradient feature values;

calculating a co-occurrence feature value in a plurality of blocks for each of the plurality of combination patterns;

calculating an addition value by adding the co-occurrence feature value for each of the read combination pattern;

generating statistical data from the addition value; and

defining a window having a predetermined size for the image and recognizing whether or not a predetermined image is included in the window based on the statistical data within the window.

### (Supplementary Note 15)

The image recognition method described in Supplementary note 14, wherein

the gradient feature value is composed of a direction of a brightness gradient and a magnitude of the brightness gradient, and

the magnitude of the brightness gradient is expressed by a binary value.

### (Supplementary Note 16)

The image recognition method described in Supplementary note 14, wherein the combination pattern is a combination of a gradient feature value in a first block and a gradient feature value in a second block.

### (Supplementary Note 17)

The image recognition method described in Supplementary note 16, wherein the combination pattern further includes information about a position of the second block relative to the first block.

### (Supplementary Note 18)

The image recognition method described in Supplementary note 14, wherein

the window is divided into a plurality of cells, each of the plurality of cells including at least two blocks,

the statistical data is generated as statistical data for each of the plurality of cells, and

the statistical data for each of the plurality of cells is unified within the window.

### (Supplementary Note 19)

The image recognition method described in Supplementary note 18, wherein

the image recognition apparatus comprises a weighting value storage unit configured to store a weighting value, and

the image recognition method further comprising:

reading the weighting value from the storage unit; and

recognizing whether or not a predetermined image is included in the window based on the statistical data and the weighting value.

### (Supplementary Note 20)

The image recognition method described in Supplementary note 19, wherein

the weighting value is a weighting vector and a bias of a support vector machine, and

it is recognized whether or not a predetermined image is included in the window based on the statistical data and the weighting value by using the support vector machine.

### (Supplementary Note 21)

The image recognition method described in Supplementary note 18, wherein the combination pattern or the weighting value is a combination pattern or a weighting value according to a position of the cell within the window.

### (Supplementary Note 22)

The image recognition method described in Supplementary note 14, further comprising performing a trimming process for a captured image.

### (Supplementary Note 23)

The image recognition method described in Supplementary note 14, further comprising converting a captured image into a plurality of images having reduced sizes.

### (Supplementary Note 24)

An image recognition method comprising:

(A) performing an image recognition process described in Supplementary note 14;

(B) determining a position of a window based on a result of (A);

(C) performing an image recognition process described in Supplementary note 14 for a plurality of windows near the determined position of the window; and

(D) recognizing whether or not a predetermined image is included based on a result of (C).

### (Supplementary Note 25)

The image recognition method described in Supplementary note 18, further comprising:

calculating the co-occurrence feature value for each block; and

successively adding the co-occurrence feature value of the block for each combination of the co-occurrence feature values and thereby generating statistical data.

The first through fourth embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. An image recognition apparatus comprising:
a gradient feature computation unit configured to calculate, from an image divided into a plurality of blocks, gradient feature values for each of the plurality of blocks;
a combination pattern storage unit configured to store a plurality of combination patterns of the gradient feature values;
a co-occurrence feature computation unit configured to calculate a co-occurrence feature value in a plurality of blocks for each of the plurality of combination patterns;
an arithmetic computation unit configured to calculate an addition value by adding the co-occurrence feature value for each of the plurality of combination patterns;
a statistical data generation unit configured to generate statistical data from the addition value; and
an image recognition computation unit configured to define a window having a predetermined size for the image and recognize whether or not a predetermined image is included in the window based on the statistical data within the window.

2. The image recognition apparatus according to claim 1, wherein
the gradient feature value is composed of a direction of a brightness gradient and a magnitude of the brightness gradient, and
the magnitude of the brightness gradient is expressed by a binary value.

3. The image recognition apparatus according to claim 1, wherein the combination pattern is a combination of a gradient feature value in a first block and a gradient feature value in a second block.

4. The image recognition apparatus according to claim 3, wherein the combination pattern further includes information about a position of the second block relative to the first block.

5. The image recognition apparatus according to claim 1, wherein
the window is divided into a plurality of cells, each of the plurality of cells including at least two blocks,
the statistical data generation unit generates statistical data for each of the plurality of cells, and
the image recognition apparatus further comprises a statistical data unification unit configured to unify the statistical data for each of the plurality of cells within the window.

6. The image recognition apparatus according to claim 5, further comprising a weighting value storage unit configured to store a weighting value, wherein
the image recognition computation unit recognizes whether or not a predetermined image is included in the window based on the statistical data and the weighting value.

7. The image recognition apparatus according to claim 6, wherein
a weighting vector and a bias of a support vector machine are stored in the weighting value storage unit, and
the image recognition computation unit comprises the support vector machine.

8. The image recognition apparatus according to claim 5, further comprising an image transformation unit configured to transform a captured image into a plurality of images having reduced sizes.

9. The image recognition apparatus according to claim 6, wherein the combination pattern storage unit or the weighting value storage unit stores a combination pattern or a weighting value according to a position of the cell within the window.

10. The image recognition apparatus according to claim 1, further comprising an image transformation unit configured to perform a trimming process for a captured image.

11. The image recognition apparatus according to claim 5, wherein the arithmetic computation unit comprises a computation unit configured to process data whose bit length is equal to or longer than a number obtained by adding up a sum total of the number of blocks within the cell and the number of combination patterns of the co-occurrence feature value.

12. An image recognition system comprising:
a camera;
a gradient feature computation unit configured to calculate, from an image divided into a plurality of blocks, gradient feature values for each of the plurality of blocks;
a combination pattern storage unit configured to store a plurality of combination patterns of the gradient feature values;
a co-occurrence feature computation unit configured to calculate a co-occurrence feature value in a plurality of blocks for each of the plurality of combination patterns;
an arithmetic computation unit configured to calculate an addition value by adding the co-occurrence feature value calculated for each of the plurality of blocks for each of the plurality of combination patterns;
a statistical data generation unit configured to generate statistical data from the addition value; and
an image recognition computation unit configured to define a window having a predetermined size for the image and recognize whether or not a predetermined image is included in the window based on the statistical data within the window.

13. The image recognition system according to claim 12, wherein
the gradient feature value is composed of a direction of a brightness gradient and a magnitude of the brightness gradient, and
the magnitude of the brightness gradient is expressed by a binary value.

14. An image recognition method performed by an image recognition apparatus, comprising:
calculating, from an image divided into a plurality of blocks, gradient feature values for each of the plurality of blocks;
reading a combination pattern of the gradient feature value from a storage unit storing a plurality of combination patterns of the gradient feature values;
calculating a co-occurrence feature value in a plurality of blocks for each of the plurality of combination patterns;
calculating an addition value by adding the co-occurrence feature value for each of the read combination pattern;
generating statistical data from the addition value; and
defining a window having a predetermined size for the image and recognizing whether or not a predetermined image is included in the window based on the statistical data within the window.

15. The image recognition method according to claim 14, wherein
the gradient feature value is composed of a direction of a brightness gradient and a magnitude of the brightness gradient, and
the magnitude of the brightness gradient is expressed by a binary value.

16. The image recognition method according to claim 14, wherein the combination pattern is a combination of a gradient feature value in a first block and a gradient feature value in a second block.

17. The image recognition method according to claim 16, wherein the combination pattern further includes information about a position of the second block relative to the first block.

18. The image recognition method according to claim 14, wherein
the window is divided into a plurality of cells, each of the plurality of cells including at least two blocks,
the statistical data is generated as statistical data for each of the plurality of cells, and
the statistical data for each of the plurality of cells is unified within the window.

19. The image recognition method according to claim 18, wherein
the image recognition apparatus comprises a weighting value storage unit configured to store a weighting value, and
the image recognition method further comprising:
reading the weighting value from the storage unit; and
recognizing whether or not a predetermined image is included in the window based on the statistical data and the weighting value.

20. An image recognition method comprising:
(A) performing an image recognition process according to claim 14;
(B) determining a position of a window based on a result of (A);
(C) performing an image recognition process according to claim 14 for a plurality of windows near the determined position of the window; and
(D) recognizing whether or not a predetermined image is included based on a result of (C).
